(19) United States
(12) Patent Application Publication
(10) Pub. No.: US 2002/0172858 A1
(43) Pub. Date: Nov. 21, 2002

(54) Thermo-dynamic battery storage unit

(76) Inventor: Daniel Ashikian, Burbank, CA (US)

Correspondence Address: Daniel Ashikian, Ph.D./Sc.D. (Ono Corp.), 1638 N. San Fernando Road, Burbank, CA, 91504, US

(21) Appl. No.: 09/854,682

(22) Filed: May 15, 2001

(51) Int. Cl. H01M 14/00

(52) U.S. Cl. 429/120; 429/83; 429/61

(57) ABSTRACT

Thermo-dynamic battery storage unit converting compressed gas energy into consumable electrical power for application uses with any device that requires battery power to function.

### BACKGROUND OF THE INVENTION

Generally, we, mankind, have had major problems with relation to batteries. The problems are defined as: The charging of batteries, servicing of batteries, the non-reusability of batteries, and the highly dangerous, hazardous, and explosive, environmentally polluting chemicals used in batteries, and their heavy weight. Our thermo-dynamic battery storage unit solves all of these issues. It generates clean, usable energy, while remaining chemical and explosion free, lightweight, recharging very fast, economical, and enviromentally friendly.

The present invation relates generally to a power device for use in any application for any electrical device that requires battery power to function. More explicitly, the present invation discloses an innovative, high power device, which does not generate any harmful, enviromentally polluting residue. It is extremely high ecologically aware in operation and design, actually replenishing clean ozone back into the atmosphere, it is long lasting, and designed to be re-usable unlike conventional units.

### OBJECTS OF THE INVENTION

The present invention relates generally to a new power device. More distinctively, it creates electrical power from compressed gas energy.

Another positive attribute of the present invantion is the reality that the compressed gas is passed through the generater, which is exchanging the heat with the generator to increase the efficiency of the generator and the turbine. It is more completely using the energy, that is stored and conserved in the thermo-dynamic battery storage unit.

### SUMMARY OF THE INVENTION

The present invention provides a unique battery system. Produces from compressed gas energy, clean usable electrical power for use in any application in any device that requires battery power to operate. The new invention is much lighter for the same energy output as the conventional units, it can be charged in minutes rather that in houres, it operates and is chemical and explosion free. The new invention is also re-usable unlike conventional batteries. It is enviromentally safe to operate, and operates at about 90% efficence.

### BRIEF DESCRIPTION OF DRAWINGS

FIG. 1 is a schematic view of the thermo-dynamic battery storage unit.

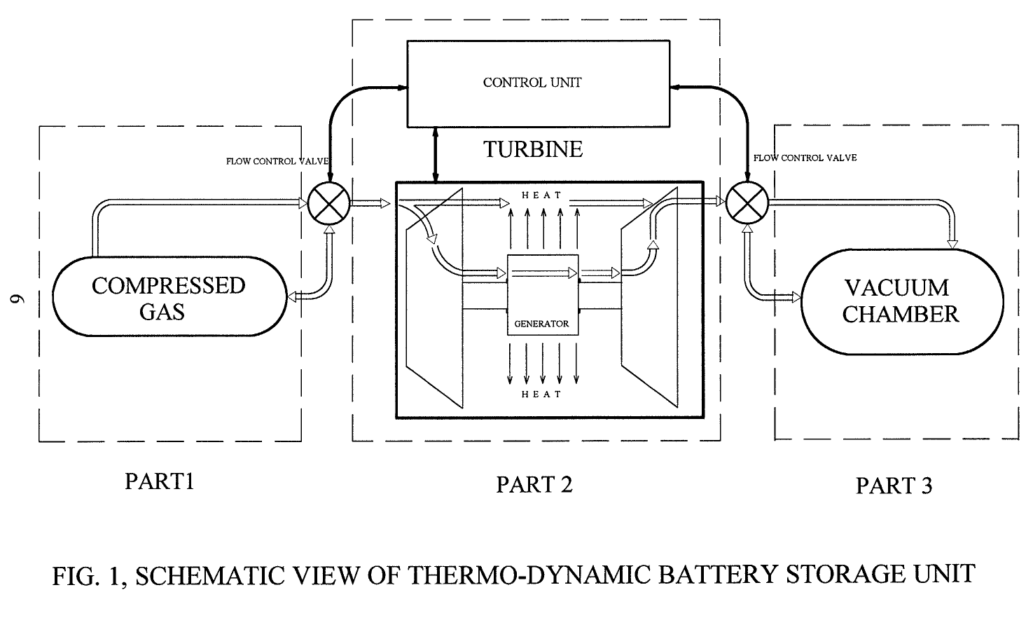

### DETAILED DESCRIPTION OF THE INVENTION

The main parts of thermo-dynamic battery storage unit are: compressed gas tank, generator connected with two turbine fan sets in serease, heat exchanger chamber and control unit. The gas passing through the first turbine fan blades will force the generator to turn, which is in turn generates electricity and heat. Generated heat expends the gas more forcing the second set of fan blades to turn, which are feedbacked to the generator with the same shaft to turn generator. The gas is delayed in the heat exchanger chamber long enough to create expected results. At the same time it cools down the generator and increases generator efficiency. Generating of electricity is controled by the control unit and flow control valve.

I claim:

1. A power device comprising: energy source;
a compressed gas storage device; and
a heat exchanger chamber; and
a generator; and
a two sets of turbine-fan device;
wherein said compressed gas storage device supplies said turbine fan device, generator and heat exchanger chamber with compressed gas through a turbine-fan device and generator: resulting in electrical power generation.

2. A power device according to claim 1, wherein said power device further comprises a heat exchanger chamber, wherein said heat exchanger chamber delays and expends the volume of the gas.

3. A power device according to claim 1, wherein said power device further comprises second set of turbine-fan device, wherein second set of turbine-fan device turnes the generator to produce electrical power.

4. A power device according to claim 1, wherein said power device further comprises a controller and flow control valve, wherein said controller and flow control valve controls the power to be consumed.

5. A power device according to claim 1, wherein said energy source is derived from compressed gas and generated heat energy converted to electrical power.

6. A power device for creating power from compressed gas and generated heat energy, said power device comprising;
energy source:
a compressed gas storage device;
a heat exchanger chamber;
a generator; and
a two sets of turbine-fan device;
wherein said turbin-fan device, generator and heat exchanger chamber receives compressed gas, wherein said compressed gas turns first set of turbine-fan device, wherein said first set of turbine-fan device turns the generator, wherein said generator produces consumable electrical power and heat, wherein said heat further expends the compressed gas, wherein said expended gas forces to turn second set of turbin-fan device, wherein said second set of turbin-fan device turns generator.

7. A power device according to claim 6, wherein said power device further comprises common shaft, wherein said shaft turnes the generator and turbine-fan device.
